(19) United States
(12) Patent Application Publication
(10) Pub. No.: US 2022/0132832 A1
(43) Pub. Date: May 5, 2022

(54) Rodent Trap Assembly

(71) Applicant: Allen Neph, Snohomish, WA (US)

(72) Inventor: Allen Neph, Snohomish, WA (US)

(21) Appl. No.: 17/088,965

(22) Filed: Nov. 4, 2020

(51) Int. Cl. A01M 25/00; A01M 23/10

(52) U.S. Cl. CPC A01M 25/004; A01M 23/10

(57) ABSTRACT

A rodent trap assembly includes a cylinder that has an access opening extending therein. A bait tray is coupled to the cylinder to contain rodent bait and the bait tray is positioned inside the cylinder. A dome is positionable on the cylinder and the dome has an entry way extending therethrough to facilitate a rodent to enter the dome to access the rodent bait in the bait tray. A ramp is removably attachable to the entry way to facilitate the rodent to access the entry way. A cup is removably positionable in the cylinder to capture the rodent when the rodent enters through the entry way and falls downwardly in the cylinder. A handle is coupled to the cup to facilitate the rodent to be relocated without requiring the user to touch the rodent.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trap devices and more particularly pertains to a new trap device for capturing rodents.

### (2) Description of Related Art Including Information Disclosed Under 37 CFR 1.97 and 1.98

The prior art relates to trap devices including a trap for capturing rodents in a bucket that includes a roller which extends across a bucket and a ramp leading to the roller. The prior art discloses a variety of rodent traps that include a container, a baited spinner and an access ramp that facilitates a rodent to access the baited spinner and subsequently fall into the container.

### BRIEF SUMMARY OF THE INVENTION

An embodiment of the disclosure meets the needs presented above by generally comprising a cylinder that has an access opening extending therein. A bait tray is coupled to the cylinder to contain rodent bait and the bait tray is positioned inside the cylinder. A dome is positionable on the cylinder and the dome has an entry way extending therethrough to facilitate a rodent to enter the dome to access the rodent bait in the bait tray. A ramp is removably attachable to the entry way to facilitate the rodent to access the entry way. A cup is removably positionable in the cylinder to capture the rodent when the rodent enters through the entry way and falls downwardly in the cylinder. A handle is coupled to the cup to facilitate the rodent to be relocated without requiring the user to touch the rodent.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rodent trap assembly according to an embodiment of the disclosure.

FIG. 2 is a front view of an embodiment of the disclosure.

FIG. 3 is a bottom view of an embodiment of the disclosure.

FIG. 4 is a back phantom view of an embodiment of the disclosure.

FIG. 5 is a perspective in-use view of an embodiment of the disclosure.

FIG. 6 is an exploded perspective view of a dome and a ramp of an embodiment of the disclosure.

### DETAILED DESCRIPTION OF THE INVENTION

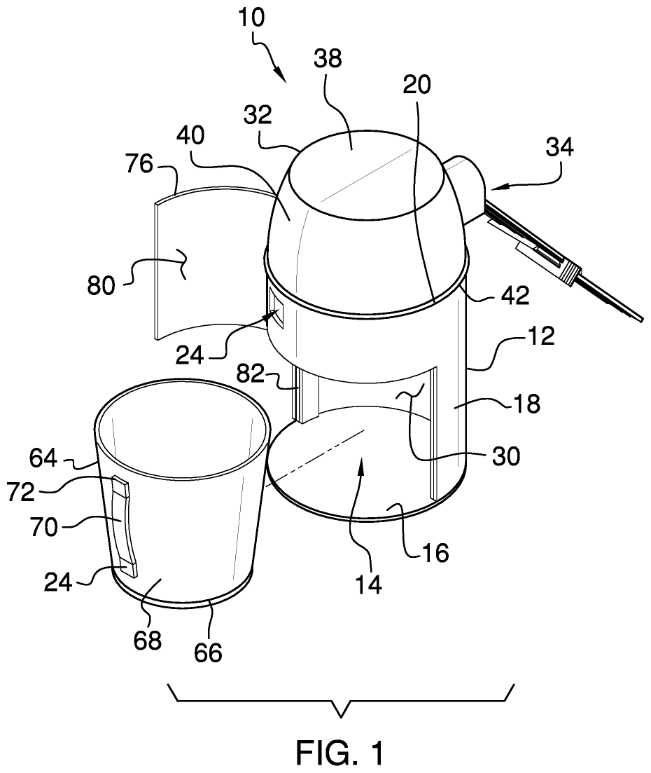

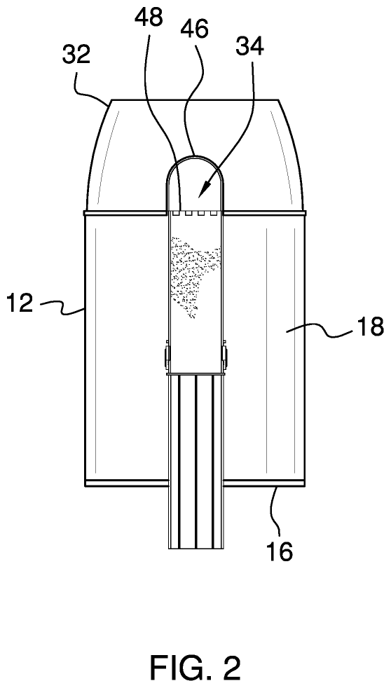

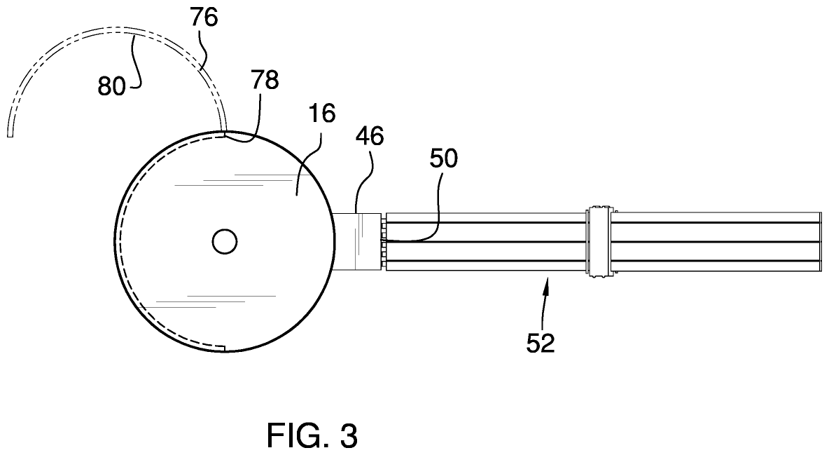

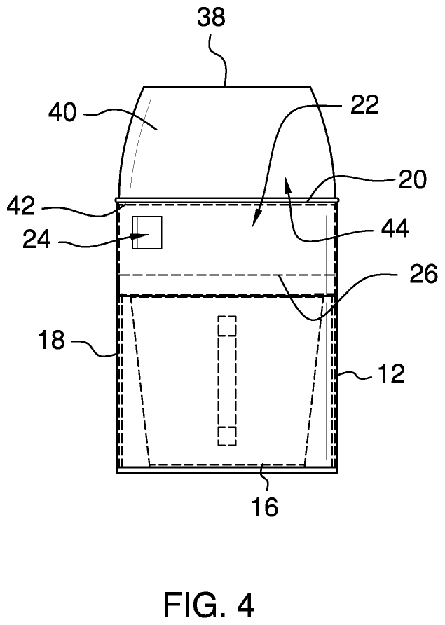

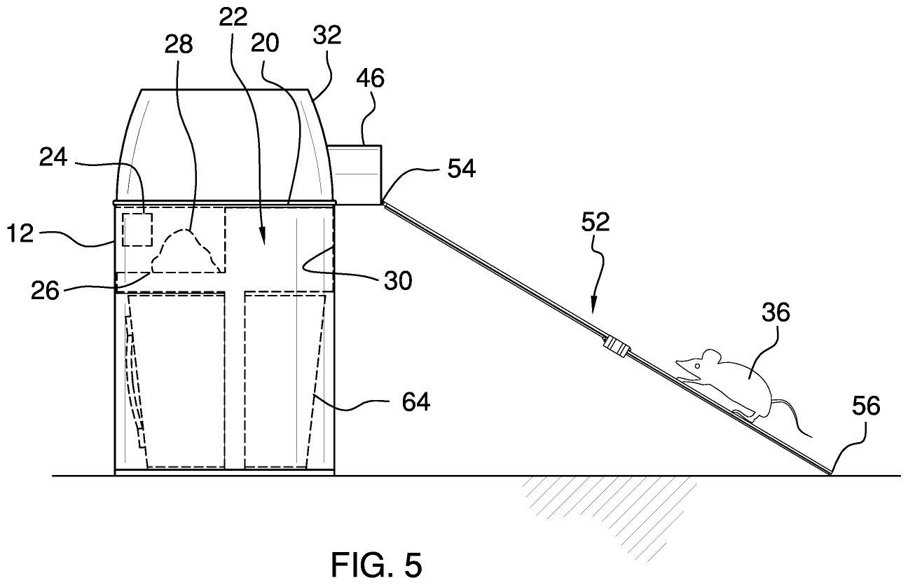

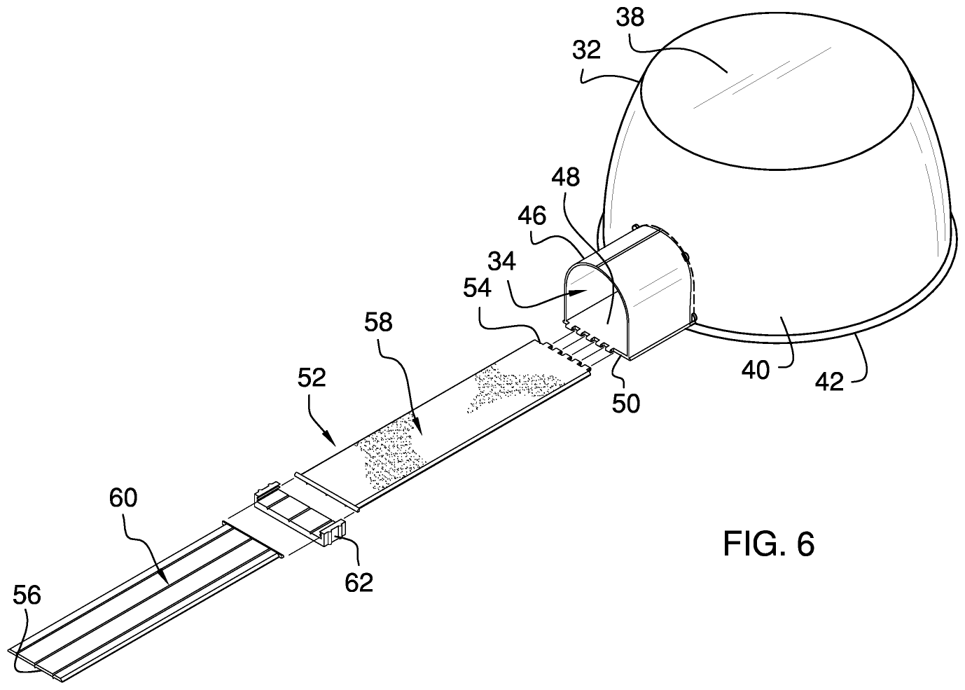

With reference now to the drawings, and in particular to FIGS. 1 through 6 thereof, a new trap device embodying the principles and concepts of an embodiment of the disclosure and generally designated by the reference numeral 10 will be described.

As best illustrated in FIGS. 1 through 6, the rodent trap assembly 10 generally comprises a cylinder 12 that has an access opening 14 extending therein. The cylinder 12 has a bottom wall 16 and an outer wall 18 extending upwardly therefrom, and the outer wall 18 has a distal edge 20 with respect to the bottom wall 16 to define an opening 22 into the cylinder 12. The access opening 14 extends through the outer wall 18 and the access opening 14 extends from the bottom wall 16 toward the distal edge 20. The outer wall 18 has a bait opening 24 extending therethrough and the bait opening 24 is positioned between the access opening 14 and the distal edge 20.

A bait tray 26 is coupled to the cylinder 12 for containing rodent bait 28. The bait tray 26 is positioned on an inside surface 30 of the outer wall 18 of the cylinder 12 and the bait tray 26 is aligned with the distal edge 20 of the cylinder 12. Additionally, the bait tray 26 is aligned with the bait opening 24 in the outer wall 18 to facilitate the rodent bait 28 to be added to the bait tray 26. The rodent bait 28 may be granular rodent bait, rodent food, rodent poison or any other suitable rodent bait.

A dome 32 is positionable on the cylinder 12 and the dome 32 has an entry way 34 extending therethrough to facilitate a rodent 36 to enter the dome 32 to access the rodent bait 28 in the bait tray 26. The dome 32 has a top wall 38 and an outside wall 40 extending downwardly therefrom, and the outside wall 40 has a distal edge 42 with respect to the top wall 38 to define an opening 44 into the dome 32. The distal edge 42 of the outside wall 40 engages the distal edge 20 of the outer wall 18 of the cylinder 12. The entry way 34 extends through the outside wall 40 and the entry way 34 includes a tunnel 46 extending outwardly from the outer wall 18. The tunnel 46 directs the rodent 36 into the entry way 34. The tunnel 46 has a floor 48, the floor 48 has a distal edge 50 with respect to the outer wall 18 of the dome 32 and the distal edge 50 is crenellated. Moreover, the entry way 34 is positioned on an opposite side of the outer wall 18 of the cylinder 12 from the bait opening 24 when the dome 32 is positioned on the cylinder 12.

A ramp 52 is removably attachable to the entry way 34 to facilitate the rodent 36 to access the entry way 34. The ramp 52 has a first end 54 and a second end 56, and the ramp 52 comprises a first section 58 that slidably engages a second section 60 such that the ramp 52 has an adjustable length. The first end 54 is associated with the first section 58 and the second end 56 is associated with the second section 60. The first end 54 is crenellated thereby facilitating the crenellation on the first end 54 to engage the crenellation on the distal edge 50 of the floor of the tunnel 46 having the ramp 52 sloping downwardly therefrom. The ramp 52 may include a collar 62 through which each of the first section 58 and the second section 60 slidably extend.

A cup 64 is removably positionable in the cylinder 12 to capture the rodent 36 when the rodent 36 enters through the entry way 34 and falls downwardly in the cylinder 12. The cup 64 has a lower wall 66 and an exterior wall 68, and the exterior wall 68 flares outwardly from the lower wall 66. The lower wall 66 rests on the bottom wall 16 of the cylinder 12 when the cup 64 is positioned in the cylinder 12. A handle 70 is coupled to the cup 64 to facilitate the rodent 36 to be relocated without requiring the user to touch the rodent 36. The handle 70 has a first end 72 and a second end 74, and each of the first end 72 and the second end 74 of the handle 70 is attached to the exterior wall 68 of the cup 64.

A door 76 is hingedly coupled to the cylinder 12 and the door 76 is positionable in an open position or a closed position for opening and closing the access opening 14 in the cylinder 12. The door 76 has a first edge 78 and a first surface 80, and the first edge 78 is hingedly coupled to a bounding edge 82 of the access opening 14. The first surface 80 is concavely arcuate such that the door 76 conforms to curvature of the outer wall 18 of the cylinder 12 when the door 76 is in the closed position.

In use, the rodent bait 28 is placed in the bait tray 26 and the ramp 52 is coupled to the entry way 34. In this way the rodent 36 can walk up the ramp 52 and enter the dome 32 through the entry way 34. The rodent 36 falls downwardly into the cup 64 when the rodent 36 enters the dome 32. Thus, the user can remove and relocate the rodent 36 without ever having to touch the rodent 36 or touch anything that the rodent 36 has touched. In this way the rodent 36 can be eliminated in a more sanitary fashion as compared to existing methods of trapping and disposing of rodents.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rodent trap assembly for facilitating a rodent to be captured and released without requiring a user to touch the rodent, said assembly comprising:
a cylinder having an access opening extending therein;
a bait tray being coupled to said cylinder wherein said bait tray is configured to contain rodent bait, said bait tray being positioned inside said cylinder;
a dome being positionable on said cylinder, said dome having an entry way extending therethrough wherein said entry way is configured to facilitate a rodent to enter said dome to access the rodent bait in said bait tray;
a ramp being removably attachable to said entry way wherein said ramp is configured to facilitate the rodent to access said entry way;
a cup being removably positionable in said cylinder wherein said cup is configured to capture the rodent when the rodent enters through said entry way and falls downwardly in said cylinder; and
a handle being coupled to said cup wherein said handle is configured to facilitate the rodent to be relocated without requiring the user to touch the rodent.

2. The assembly according to claim 1, wherein said cylinder has a bottom wall and an outer wall extending upwardly therefrom, said outer wall having a distal edge with respect to said bottom wall to define an opening into said cylinder, said access opening extending through said outer wall, said access opening extending from said bottom wall toward said distal edge.

3. The assembly according to claim 2, wherein said outer wall has a bait opening extending therethrough, said bait opening being positioned between said access opening and said distal edge, said entry way being positioned on an opposite side of said outer wall from said bait opening.

4. The assembly according to claim 3, wherein said bait tray is positioned on an inside surface of said outer wall of said cylinder, said bait tray being aligned with said distal edge of said cylinder, said bait tray being aligned with said bait opening in said outer wall wherein said bait opening is configured to facilitate the rodent bait to be added to said bait tray.

5. The assembly according to claim 2, wherein said dome has a top wall and an outside wall extending downwardly therefrom, said outside wall having a distal edge with respect to said top wall to define an opening into said dome, said distal edge of said outside wall engaging said distal edge of said outer wall of said cylinder, said entry way extending through said outside wall.

6. The assembly according to claim 5, wherein said entry way includes a tunnel extending outwardly from said outer wall wherein said tunnel is configured to direct the rodent into said entry way, said tunnel having a floor, said floor having a distal edge with respect to said outer wall of said dome, said distal edge being crenellated.

7. The assembly according to claim 6, wherein said ramp has a first end and a second end, said ramp comprising a first section slidably engaging a second section such that said ramp has an adjustable length, said first end being associated with said first section, said second end being associated with said second section, said first end being crenellated thereby facilitating said crenellation on said first end to engage said crenellation on said distal edge of said floor of said tunnel having said ramp sloping downwardly therefrom.

8. The assembly according to claim 2, wherein said door has a first edge and a first surface, said first edge being hingedly coupled to a bounding edge of said access opening, said first surface being concavely arcuate such that said and door conforms to curvature of said outer wall of said cylinder when said door is in said closed position,

8. The assembly according to claim 2, wherein:
said cup has a lower wall and an exterior wall, said exterior wall flares outwardly from said lower wall, said lower wall resting on said bottom wall of said cylinder when said cup is positioned in said cylinder; and
said handle has a first end and a second end, each of said first end and said second end of said handle being attached to said exterior wall of said cup.

9. A rodent trap assembly for facilitating a rodent to be captured and released without requiring a user to touch the rodent, said assembly comprising:
a cylinder having an access opening extending therein, said cylinder having a bottom wall and an outer wall extending upwardly therefrom, said outer wall having a distal edge with respect to said bottom wall to define an opening into said cylinder, said access opening extending through said outer wall, said access opening extending from said bottom wall toward said distal edge, said outer wall having a bait opening extending therethrough, said bait opening being positioned between said access opening and said distal edge, said entry way being positioned on an opposite side of said outer wall from said bait opening;
a bait tray being coupled to said cylinder wherein said bait tray is configured to contain rodent bait, said bait tray being positioned on an inside surface of said outer wall of said cylinder, said bait tray being aligned with said distal edge of said cylinder, said bait tray being aligned with said bait opening in said outer wall wherein said bait opening is configured to facilitate the rodent bait to be added to said bait tray;
a dome being positionable on said cylinder, said dome having an entry way extending therethrough wherein said entry way is configured to facilitate a rodent to enter said dome to access the rodent bait in said bait tray, said dome having a top wall and an outside wall extending downwardly therefrom, said outside wall having a distal edge with respect to said top wall to define an opening into said dome, said distal edge of said outside wall engaging said distal edge of said outer wall of said cylinder, said entry way extending through said outside wall, said entry way including a tunnel extending outwardly from said outer wall wherein said tunnel is configured to direct the rodent into said entry way, said tunnel having a floor, said floor having a distal edge with respect to said outer wall of said dome, said distal edge being crenellated;
a ramp being removably attachable to said entry way wherein said ramp is configured to facilitate the rodent to access said entry way, said ramp having a first end and a second end, said ramp comprising a first section slidably engaging a second section such that said ramp has an adjustable length, said first end being associated with said first section, said second end being associated with said second section, said first end being crenellated thereby facilitating said crenellation on said first end to engage said crenellation on said distal edge of said floor of said tunnel having said ramp sloping downwardly therefrom;
a cup being removably positionable in said cylinder wherein said cup is configured to capture the rodent when the rodent enters through said entry way and falls downwardly in said cylinder, said cup having a lower wall and an exterior wall, said exterior wall flaring outwardly from said lower wall, said lower wall resting on said bottom wall of said cylinder when said cup is positioned in said cylinder;
a door being hingedly coupled to said cylinder, said door being positionable in an open position or a closed position for opening and closing said access opening in said cylinder, said door having a first edge and a first surface, said first edge being hingedly coupled to a bounding edge of said access opening, said first surface being concavely arcuate such that said and door conforms to curvature of said outer wall of said cylinder when said door is in said closed position; and
a handle being coupled to said cup wherein said handle is configured to facilitate the rodent to be relocated without requiring the user to touch the rodent, said handle having a first end and a second end, each of said first end and said second end of said handle being attached to said exterior wall of said cup.
